(19) United States
(12) Patent Application Publication
(10) Pub. No.: US 2009/0078918 A1
(43) Pub. Date: Mar. 26, 2009

(54) Methods and Structures With Fire Retardant Spheres for Implementing Enhanced Fire Protection

(76) Inventors: Cary Michael Huettner, Rochester, MN (US); Joseph Kuczynski, Rochester, MN (US); Matthew Carl Zehrer, Saint Paul, MN (US)

Correspondence Address: IBM CORPORATION;ROCHESTER IP LAW DEPT 917, 3605 HIGHWAY 52 N, ROCHESTER, MN, 55901-7829, US

(21) Appl. No.: 11/860,713

(22) Filed: Sep. 25, 2007

(51) Int. Cl. C09K 21/00; B05D 7/00

(52) U.S. Cl. 252/601; 427/212

(57) ABSTRACT

A method and fire retardant structures including fire retardant spheres are provided for implementing enhanced fire protection. A selected first fire retardant material is encapsulated in microspheres. The microspheres have a predefined melting temperature within a defined temperature range. The fire retardant structure is formed of the microspheres encapsulating the selected fire retardant material and included in an article being produced. In response to a fire event, the microspheres rupture or decompose releasing the encapsulated material to provide fire suppression. Alternatively, a fire retardant structure is formed of second microspheres having predefined expansion characteristics. A layer of the second microspheres is disposed between two layers of an article being produced. In response to a thermal fire event, the microspheres expand to fill the space between the layers, providing fire suppression

### FIELD OF THE INVENTION

The present invention relates generally to the manufacturing field, and more particularly, relates to a method and structures including fire retardant spheres for implementing enhanced fire protection.

### DESCRIPTION OF THE RELATED ART

Today various solutions are used to control fire and the associated thermal energy to prevent damage or loss of life.

Typical fire-extinguishing foams are termed aqueous film forming foam (AFFF) and consist of perfluorinated surfactants synthesized from perflourooctyl sulfonate (PFOS). PFOS is environmentally persistent and bioaccumulative and has come under intense scrutiny. Suitable replacements are also fluorinated surfactants and may also be deemed environmentally unacceptable.

A need exists for a new solution to control and abate potentially dangerous situations from getting out of control, or at least controlling the situation long enough to save life and property that allows for broad applications, such as, within fabric, foam, plywood, firewalls, gas tanks, enclosures and shields that are integrated into various products, such as, electronic equipment, housing materials, furniture, ash trays, mattresses, tanks, automobile floors and firewalls.

### SUMMARY OF THE INVENTION

Principal aspects of the present invention are to provide a method and structures including fire retardant spheres for implementing enhanced fire protection. Other important aspects of the present invention are to provide such method and structures including fire retardant spheres for implementing enhanced fire protection substantially without negative effect and that overcome many of the disadvantages of prior art arrangements.

In brief, a method and fire retardant structures including fire retardant spheres are provided for implementing enhanced fire protection. A selected fire retardant material is encapsulated in microspheres. The microspheres have a melting temperature. The fire retardant structure is formed of the microspheres encapsulating the fire retardant material and included in an article being produced. In response to a thermal fire event, the microspheres rupture or decompose releasing the encapsulated material to provide fire suppression.

In accordance with a preferred embodiment of the invention, a fire retardant structure alternatively is formed of second microspheres having predefined expansion characteristics. A layer of the second microspheres is disposed between two layers of an article being produced. In response to a thermal fire event, the microspheres expand to fill the space between the layers, providing fire suppression.

In accordance with features of the invention, the selected fire retardant material includes a selected biodegradable flame arresting material. The selected fire retardant material can include a thermally degradable material for forming an inert blanketing gas. Also a combination of a selected biodegradable flame arresting material and a thermally degradable material for forming an inert blanketing gas are respectively encapsulated in microspheres used to form the structures of the invention.

In accordance with features of the invention, the fire retardant structure forms a sheet integrated into a fabric, foam, plywood, firewall, gas tank, enclosure, shield of a particular article of manufacture.

### BRIEF DESCRIPTION OF THE DRAWINGS

The present invention together with the above and other objects and advantages may best be understood from the following detailed description of the preferred embodiments of the invention illustrated in the drawings, wherein:

FIG. 1 is a flow chart illustrating exemplary steps for implementing a methods and structures for enhanced fire protection in accordance with the preferred embodiment; and

FIGS. 2A and 2B and FIGS. 3A and 3B illustrate respective exemplary structures for implementing enhanced fire protection in accordance with the preferred embodiment.

### DETAILED DESCRIPTION OF THE PREFERRED EMBODIMENTS

In accordance with features of the invention, an effective method is provided for implementing enhanced fire protection. Microspheres with a set melting temperature encapsulate a selected fire retardant material. Then at a given temperature the microspheres burst, and the fire retardant material is released.

In accordance with features of the invention, a fire retardant structure alternatively is formed of second microspheres having predefined expansion characteristics. A layer of the second microspheres is disposed between two layers of a structure. In response to a thermal fire event, the microspheres expand to fill the space between the layers, providing fire suppression.

In accordance with features of the invention, the fire retardant microspheres form structures, such as sheets, that advantageously are integrated into fabric, foam, plywood, firewalls, gas tanks, enclosures, shields, and the like. Many different laminated structures can be created. The microspheres are designed to burst or decompose at a given temperature whereby the fire retardant material is released to suppress a fire. This fire suppression action can either stop or abate the fire to prevent harm to individuals and effectively provide additional time to escape.

In accordance with features of the invention, the fire retardant material is a selected environmentally suitable material, and typical fire-extinguishing foams are not used to create the fire retardant microspheres of the invention. Thus, aqueous film forming foam (AFFF) consisting of perfluorinated surfactants synthesized from perflourooctyl sulfonate (PFOS) and other fluorinated surfactants that are environmentally persistent and bioaccumulative generally are unacceptable.

In accordance with features of the invention, the fire retardant microspheres form structures that are integrated into many products. Some product examples are housing materials, fabrics, furniture, ashtrays, mattresses, tanks, automobile floors, firewalls, and the like. The fire retardant microspheres form structures that advantageously are used to protect electronic equipment. Potential military applications are ships, submarines, airplanes, tanks, hummers, and the like.

In accordance with features of the invention, blowing agents are encapsulated that trigger at predetermined temperatures and decompose to various gases, such as nitrogen. As another embodiment of the invention, the microspheres merely encapsulate the blowing agent. As the temperature rises, the blowing agent decomposes to form a gas, such as nitrogen and carbon dioxide, both of which would extinguish a fire, which due to the huge increase in volume while going from a solid to a gas, ruptures the shell and extinguishes the fire.

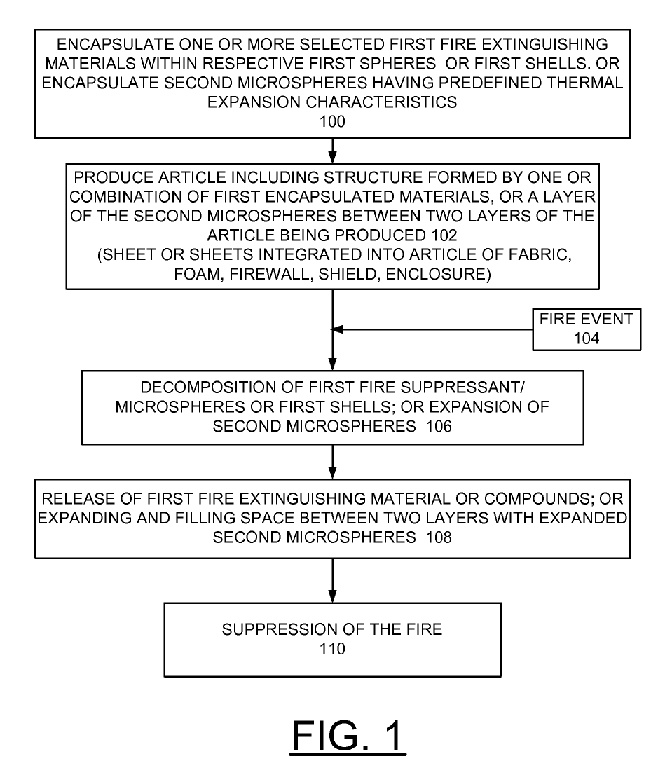

Having reference now to the drawings, in FIG. 1, there are shown exemplary steps for implementing a method and structure for enhanced fire protection in accordance with the preferred embodiment.

A selected one or more first fire extinguishing materials are encapsulated within respective first spheres or first shells; or second microspheres having predefined thermal expansion characteristics are encapsulated, as indicated at a block 100. The first spheres or first shells encapsulating the first selected fire extinguishing materials are first microspheres with a set melting temperature. A selected product or an article of manufacture is produced including a structure formed by one or a combination of the first encapsulated materials; or a layer of the second microspheres are provided between two layers of the article being produced, as indicated at a block 102. The encapsulated materials, for example, form a sheet that is integrated into the product, such as, a fabric, a foam, a firewall, a shield, an enclosure, and the like, at block 102.

In use, when a fire event occurs as indicated at a block 104, then the first fire suppressant microspheres or shells decompose or rupture; or the second microspheres expand, as indicated at a block 106. The encapsulated fire extinguishing material or compounds are released; or expanding and filling the space between the two layers with the expanded second microspheres is provided responsive to the thermal event, as indicated at a block 108 for implementing suppression of the fire as indicated at a block 110.

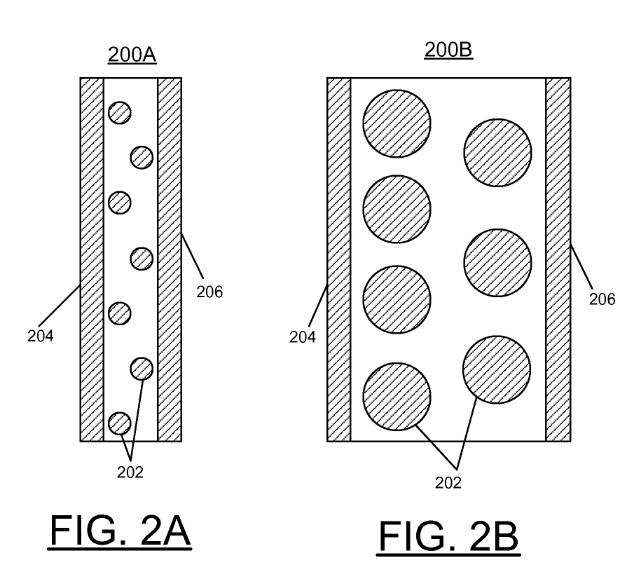

FIGS. 2A and 2B illustrate an exemplary structure respectively generally designated by the reference character 200A, 200B for implementing enhanced fire protection in accordance with the preferred embodiment.

In FIG. 2A the structure 200A is shown in a normal or nominal view. The structure 200A include a plurality of second microspheres 202 having predefined thermal expansion characteristics arranged in a layer between two layers 204, 206 of the article being produced. The two layers 204, 206 of the article being produced are formed, for example, of sheet rock, wood, sheet metal, and the like.

In FIG. 2B the structure 200B is shown in an expanded view after a thermal event expanding and filling the space between the two layers 204, 206 with the expanded second microspheres 202.

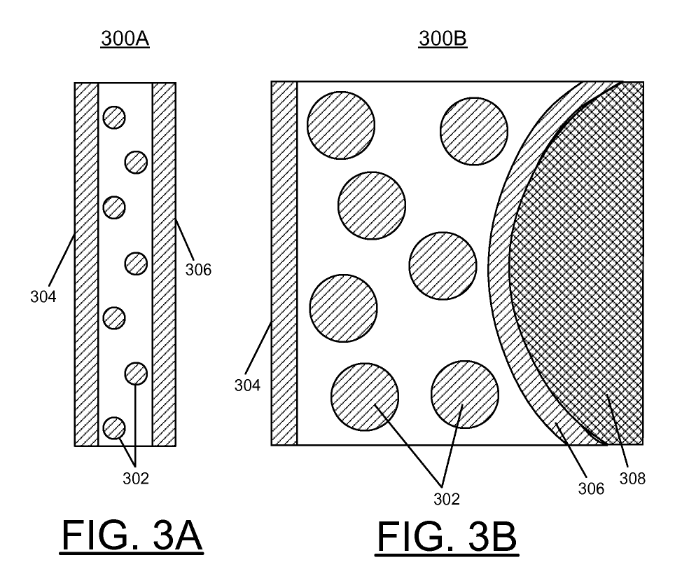

FIGS. 3A and 3B illustrate an exemplary structure respectively generally designated by the reference character 300A, 300B for implementing enhanced fire protection in accordance with the preferred embodiment.

In FIG. 3A the structure 300A is shown in a normal or nominal view. The structure 300A include a plurality of second microspheres 302 having predefined thermal expansion characteristics arranged in a layer between two layers 304, 306 of the article being produced. The second layer 306 is formed of a flexible material.

In FIG. 3B the structure 300B is shown in an expanded view after a thermal event expanding and filling the space between the two layers 304, 306 with the expanded second microspheres 302. The second layer 306 formed of the flexible material is conformable, to some degree, against a non-flat mating member 308 responsive to the thermal event.

As shown in both FIGS. 2B, and 3B, in the expanded states of the second microspheres 202, 302, the distance between the layers 204, 206 and 304, 306 of respective structures 200B, 300B is increased effectively providing a fire suppressing barrier responsive to the thermal event.

A selected fire extinguishing material encapsulated at block 100 includes, for example, but is not limited to a selected one of the following fire extinguishing/flame arresting materials including:

### Halotron (HCFC 123);

FE-36 (Dupont trademark; HFC-236fa);
FE-25 (pentafluoroethane);
FE-227 (HFC-227ea);

### FE-13 (HFC-23);

Aluminium hydroxide;
Magnesium hydroxide and various hydrates;
Organobromines and organochlorines;
Phosphorus, in the form of organophosphates, halogenated phosphorus compounds, and red phosphorus;
Antimony trioxide;
Boron compounds, mainly as borates;
Tetrakis(hydroxymethyl) phosphonium salts;
Chlorinated paraffins;
Tri-o-cresyl phosphate;
Tris(2,3-dibromopropyl) phosphate (TRIS);
Bis(2,3-dibromopropyl) phosphate;
Tris(1-aziridinyl)-phosphine oxide (TEPA).

A selected fire extinguishing material encapsulated at block 100 includes, for example, thermally degradable material for forming an inert blanketing gas. The microspheres advantageously encapsulate commercially available products that thermally decompose to form gaseous products at predefined trigger temperatures.

Such thermally degradable materials for forming an inert blanketing gas include various compounds, such as, plastic foaming agents such as azo compounds, for example, azodicarbonamide blowing agents, and sulfonyl hydrazides, for example, one or more of the sulfonylhydrazide compounds sold commercially under the tradename “Celogen” by Chemura Corporation, located in Middlebury, Conn.

Azo compounds decompose at specific trigger temperatures to form nitrogen gas plus other non-oxidizing gaseous products. In general, any compound that thermally decomposes to gaseous products, with the stipulation that the gaseous product be non-oxidizing, at a desired trigger temperature is suitable as the flame arresting material. For example, calcium oxalate decomposes by loss of water (as steam) at elevated temperature and hence is a suitable fire extinguishing agent.

In accordance with features of the invention, microspheres, such as a type of microspheres manufactured and sold by Akzo Nobel Company under the mark EXPANCEL may be used for the second microspheres. EXPANCEL® microspheres consist of a small amount of a hydrocarbon gas encapsulated by a gas-tight thermoplastic shell. When the microspheres are heated, the thermoplastic shell softens and the hydrocarbon inside the shell increases its pressure. This results in a dramatic expansion of the spheres (typically from 10 μm to 40 μm diameter). The EXPANCEL® microspheres are available with expansion temperatures in the range of 80-190 C. The temperature of expansion onset as well as the temperature at which the maximum expansion is obtained depends on the heating rate. EXPANCEL® microspheres can withstand thousands of cycles of loading/unloading without collapsing or breaking and can be used in contact with many chemicals, including solvents, without any negative effects on expansion or other thermomechanical properties.

It should be understood that all of the above are non-limiting examples; various other materials that serve as suitable fire extinguishing compounds are known to those skilled in the art and could also be encapsulated without deviating from the scope of the invention.

Various known techniques to encapsulate materials within microspheres are known to those skilled in the art. The selected one or more fire extinguishing materials are encapsulated within respective microspheres with a set melting temperature, or predefined thermal expansion characteristics, at block 100, using techniques known to those skilled in the art, forming microcapsules.

Prior art techniques include those whereby the microcapsule is manufactured from gelatin via a simple precipitation process, for example, as disclosed in U.S. Pat. No. 2,183,053 issued Dec. 12, 1939 to Taylor, or a more complex precipitation process such as those generally described in U.S. Pat. Nos. 2,800,457 and 2,800,458 issued Jul. 23, 1957 to Green et al.

More generally, microcapsules may also be formed by two well-known processes: complex coacervation and interfacial polymerization. Complex coacervation is conducted in aqueous media and is used to encapsulate water insoluble liquids. Gelatin and gum arabic (both natural products) are the two major raw materials used in the manufacture of microcapsule shells. In this case, the gelatin is dissolved in warm water and the water-insoluble substance to be encapsulated is dispersed therein. Gum arabic and water are added, the pH adjusted to approximately 4.0, and a complex coacervate of gelatin and gum arabic is formed surrounding the water-insoluble material. The gelatin is subsequently crosslinked, typically with an aldehyde such as formaldehyde or gluteraldehyde. Various other crosslinkers are known, including polyfunctional carbodiimides, anhydrides, and aziridines.

Interfacial polymerization involves the reaction of various monomers at the interface between two immiscible liquid phases to form a polymer film that encapsulates the dispersed phase. The monomers diffuse together and rapidly polymerize at the interface of the two phases. The degree of polymerization can be controlled by monomer reactivity, concentration, composition of either phase, and temperature. Microcapsules produced in this fashion may have shell walls comprised of polyamides, polyureas, polyurethanes, and polyesters, for example, as disclosed in U.S. Pat. No. 3,516,941 issued Jun. 23, 1970 to Matson; U.S. Pat. No. 3,860,565 issued Jan. 14, 1975 to Barber, Jr., U.S. Pat. No. 4,056,610 issued Nov. 1, 1977 to Barber Jr. et al., and U.S. Pat. No. 4,756,906 issued Jul. 12, 1988 to Sweeny. Post-crosslinking of the shell wall of these microcapsules with polyfunctional aziridines reduces porosity and improves structural integrity.

U.S. Pat. No. 3,516,941, issued Jun. 23, 1970 to Matson, teaches a process for the fabrication of microcapsules on the order of 5-25 microns. The process consists of the following steps. An aqueous insoluble fill material is dispersed into the precondensate prepared via dissoultion of a water soluble, low MW urea-aldehyde precondensate comprising predominantly low MW reaction products of urea and formaldehyde (e.g., dimethylol urea) with a solids content of approximately 3-30 wt % of the aqueous precondensate. The resultant dispersion is maintained at a temperature of 10 C-50 C while the pH is adjusted to 1.0-3.5 by acid addition to initiate polymerization of the precondensate. The solution is rapidly agitated at 20 C-90 C for a time interval of at least one hour whereupon an aqueous slurry of water insoluble microcapsules with a urea-formaldehyde shell is formed.

U.S. Pat. No. 5,401,505, issued Mar. 28, 1995 to Duell et al., teaches the fabrication of microcapsules from polyfunctional aziridines. In this case, the shell wall is prepared via interfacial polymerization of a polyfunctional aziridine with at least one other polyfunctional coreactant selected from the class consisting of polyacid halides, polycarboxylic acids, polyamines, polyhydroxyl-containing compounds, polythiol-containing compounds, polyisocyanates, polyisothiocyanates, and mixtures thereof. The use of polyfunctional aziridines presents a number of advantages over the prior art. For example, polyfunctional aziridines readily react via interfacial polymerization with a wide variety of other organic polyfunctional groups in both aqueous and water-insoluble media. This breadth of reactivity with other functional groups enables the fabrication of microcapsules with shell walls covering a range of porosities, solubility characteristics, and mechanical and structural properties.

Any of the above-described techniques can be used to encapsulate the selected fire retardant material. The method described in U.S. Pat. No. 5,401,505 affords the greatest latitude in structural properties, and producing microcapsules that can be stored as discrete materials.

While the present invention has been described with reference to the details of the embodiments of the invention shown in the drawing, these details are not intended to limit the scope of the invention as claimed in the appended claims.

What is claimed is:

1. A method for implementing enhanced fire protection comprising the steps of:
encapsulating a selected fire retardant material providing a plurality of microspheres; said microspheres including first microspheres having a predefined melting temperature and second microspheres having predefined thermal expansion characteristics;
forming a first fire retardant structure of said first microspheres encapsulating the selected fire retardant material and providing said first fire retardant structure in an article being produced, and forming a second fire retardant structure of said second microspheres having predefined thermal expansion characteristics and providing said second fire retardant structure in an article being produced, and
responsive to a thermal event, said first microspheres rupture or decompose releasing the encapsulated material to provide fire suppression; and said second microspheres expand, filling a space between a pair of layers of the article being produced to provide fire suppression.

2. The method for implementing enhanced fire protection as recited in claim 1 wherein encapsulating said selected first fire retardant material includes encapsulating a selected biodegradable flame arresting material and providing a plurality of microspheres.

3. The method for implementing enhanced fire protection as recited in claim 1 wherein encapsulating said selected first fire retardant material includes encapsulating a thermally degradable material and providing a plurality of microspheres for forming an inert blanketing gas responsive to a thermal event.

4. The method for implementing enhanced fire protection as recited in claim 1 wherein encapsulating said selected fire retardant material includes encapsulating a selected biodegradable flame arresting material and providing a plurality of microspheres; and encapsulating a thermally degradable material and providing a plurality of microspheres for forming an inert blanketing gas responsive to a thermal event.

5. The method for implementing enhanced fire protection as recited in claim 4 wherein forming a fire retardant structure of said microspheres encapsulating the selected fire retardant material includes forming a fire retardant structure of a combination of said microspheres encapsulating said selected fire retardant material and said microspheres encapsulating said thermally degradable material.

6. The method for implementing enhanced fire protection as recited in claim 1 wherein forming said second fire retardant structure of said second microspheres and providing said second fire retardant structure in an article being produced includes forming a layer of said second microspheres between the pair of layers of the article being produced.

7. The method for implementing enhanced fire protection as recited in claim 1 wherein forming said first fire retardant structure and providing said first fire retardant structure in an article being produced includes integrating said first fire retardant structure into a selected one of a fabric of said article being produced; a firewall of said article being produced; an enclosure of said article being produced, and a shield of said article being produced.

8. A fire retardant structure for implementing enhanced fire protection comprising:
a plurality of microspheres; said microspheres having predetermined thermal expansion characteristics;
a fire retardant layer being formed of said plurality of said microspheres and included between two layers in an article being produced; and
responsive to a thermal event, said microspheres expanding to substantially fill the space between the two layers to provide fire suppression.

9. The fire retardant structure for implementing enhanced fire protection as recited in claim 8 wherein said microspheres expanding to fill the space between the two layers to provide fire suppression, increases a distance between the two layers.

10. The fire retardant structure for implementing enhanced fire protection as recited in claim 8 wherein said microspheres expanding to fill the space between the two layers to provide fire suppression, moves a flexible one of the two layers to conform to a shape of a mating member of the article being produced.

11. The fire retardant structure for implementing enhanced fire protection as recited in claim 8 wherein said microspheres include a gas-tight thermoplastic shell encapsulating a hydrocarbon gas.

12. A fire retardant structure for implementing enhanced fire protection comprising:
a plurality of microspheres encapsulating a selected fire retardant material; said microspheres have a melting temperature;
a fire retardant member being formed of said plurality of microspheres and included in an article being produced; and
said microspheres decomposing and releasing said encapsulated material to provide fire suppression responsive to a thermal event.

13. The fire retardant structure for implementing enhanced fire protection as recited in claim 12 wherein said selected fire retardant material includes a selected biodegradable flame arresting material.

14. The fire retardant structure for implementing enhanced fire protection as recited in claim 12 wherein said selected fire retardant material includes a selected thermally degradable material for forming an inert blanketing gas responsive to a thermal event.

15. The fire retardant structure for implementing enhanced fire protection as recited in claim 12 wherein said selected fire retardant material includes a combination of a selected biodegradable flame arresting material and a selected thermally degradable material for forming an inert blanketing gas responsive to a thermal event.

16. The fire retardant structure for implementing enhanced fire protection as recited in claim 12 wherein said fire retardant member being formed of said plurality of microspheres and included in an article being produced includes a sheet formed of said plurality of microspheres.

17. The fire retardant structure for implementing enhanced fire protection as recited in claim 12 wherein said fire retardant member is formed of a combination of a plurality of said microspheres encapsulating said selected fire retardant material and a plurality of said microspheres encapsulating a thermally degradable material for forming an inert blanketing gas responsive to a thermal event.

18. The fire retardant structure for implementing enhanced fire protection as recited in claim 12 wherein said fire retardant member being formed of said plurality of microspheres and included in an article being produced includes said fire retardant member integrated into a firewall of said article being produced.

19. The fire retardant structure for implementing enhanced fire protection as recited in claim 12 wherein said fire retardant member being formed of said plurality of microspheres and included in an article being produced includes said fire retardant member integrated into an enclosure of said article being produced.

20. The fire retardant structure for implementing enhanced fire protection as recited in claim 12 wherein said fire retardant member being formed of said plurality of microspheres and included in an article being produced includes said fire retardant member integrated into a fabric of said article being produced.
